(19) United States
(12) Patent Application Publication
(10) Pub. No.: US 2005/0076838 A1
(43) Pub. Date: Apr. 14, 2005

(54) Method for the gentle conveyance of sensitive adhesives and an arrangement for performing such a method

(76) Inventor: Siegfried Seifer, Wuppertal (DE)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 10/781,256

(22) Filed: Feb. 18, 2004

(30) Foreign Application Priority Data
Oct. 11, 2003 (DE) 10347333.5

(51) Int. Cl. B05C 11/00

(52) U.S. Cl. 118/694

(57) ABSTRACT

An arrangement for conveying adhesives to an applicator comprising a pressurized material vessel and a supply vessel, wherein the pressurized material vessel and the supply vessel are connected to one another by a pipe, which can be shut off by a valve and wherein the adhesive can be conveyed from the supply vessel into the pressurized material vessel solely by exertion of pressure.

### CROSS-REFERENCE TO RELATED APPLICATION

This application claims priority to German Patent Application No. 10347333.5, filed on Oct. 11, 2003, the entire contents of which are hereby incorporated herein in its entirety.

### BACKGROUND OF THE INVENTION

The invention initially relates to a method for the gentle conveyance of sensitive adhesives such as dispersion adhesives and/or abrasive media, whereby the adhesive or the medium is conveyed from a pressurized material vessel to an applicator such as a spray gun.

From the prior art, methods are known for applying dispersion adhesives or the like to the material to be bonded via an applicator, such as a spray gun. The main fields of application for dispersion adhesives are to be found in the wood-processing industry, the packaging industry and in the manufacture of foil- or textile-laminated moldings. Furthermore, it is also known how dispersion adhesives or the like can be fed, for example to a spray gun, which is also known from utility model DE 297 14 302 U1, the entire contents of which are hereby incorporated herein in its entirety, via a pressurized material tank. Such a pressurized material vessel is known from DE 100 62 993 A1, the entire contents of which are hereby incorporated herein in its entirety, for example.

The invention is based on the problem of how to improve a method for the gentle conveyance of sensitive adhesives or the like.

### SUMMARY OF THE INVENTION

The problem is solved by intermittently refilling the pressurized material vessel from a supply vessel intermittently, applying negative and positive pressure, as a result of which a method is established which is characterized by gentle conveyance of sensitive adhesives, such as dispersion adhesives and/or abrasive media, whereby the process-assured handling of the adhesives or other media is assured in the application of such abrasive or corrosive media. An element here is also the fact that the method can be performed without using a mechanically-acting pump. The preferred embodiment is where the refilling is accomplished by generating negative pressure in the pressurized material vessel, and simultaneously forcing a valve in a connecting pipe between the pressurized material vessel and the supply vessel into an open position. The valve can be a slide valve or the like. However, there could also be a design where the valve in this connection can even take the form of a non-return valve. An alternative method specifies that the refilling is performed, in an arrangement with the supply vessel above the pressurized material vessel, by means of positive pressure acting on the supply vessel in the form of potential energy and atmospheric pressure after a valve in a connecting pipe between the pressurized material vessel and the supply vessel has been forced into an open position.

There can also be two pressurized material tanks and one of the pressurized material tanks is refilled without the positive pressure discharge of the other pressurized material tank having to be interrupted. In such a case, the two pressurized material tanks would again be connected to one another via a pipe which can be shut off with a valve. If one of the pressurized material tanks is being refilled because of negative pressure, the valve in the connecting pipe is closed. Then the other pressurized material tank could also be refilled in turn from the refilled pressurized material tank without any interruption, because of positive pressure.

The above methods can also be applied in combination. For example, in addition to the effect of potential energy, pressure may be applied in the supply vessel and/or negative pressure may be generated in the pressurized material vessel. Whilst when the pressurized material vessel is being operated at positive pressure a realistic pressure level should be approximately 5 to 8 bar, the specified negative pressure can be 0.5 bar, for example. In addition, the 0.5 bar stated may even be sufficient as positive pressure acting or applied in the supply vessel. Since in such a case, in particular, the rate of refilling dependent on that pressure is heavily dependent, higher pressures can also be used.

The invention also relates to an arrangement for a pressurized material vessel and a supply vessel for conveying sensitive adhesives such as dispersion adhesives and/or abrasive media to an applicator such as a spray gun. In order to develop a generic arrangement which is advantageous for use, it is proposed that the pressurized material vessel and the supply vessel be connected to one another via a pipe which can be shut off with a valve and that it be possible for the adhesive and/or the medium to be conveyed from the supply vessel into the pressurized material vessel solely by applying pressure. This application of pressure can take place by gravity, for example. For this purpose, the supply vessel is positioned at a suitable height in relation to the pressurized material vessel. Another preferred embodiment is where negative pressure can be generated in the pressurized material vessel in order to convey material out of the supply vessel, whereby positive pressure either exists or can be generated in the supply vessel by potential energy and/or increasing the pressure. The valve mentioned in the pipe between the supply vessel and the pressurized material vessel may, within the meaning of the invention, also be a non-return valve which opens automatically upon generation of negative pressure in the pressurized material vessel or upon a pressure increase in the supply vessel, permitting passage of the medium in order to fill the pressurized material vessel. Furthermore, it is also proposed that the pressurized material vessel be allocated a level measuring device which, in a favorable manner, continuously measures the level of the medium inside the pressurized material vessel, whereby, as necessary, negative pressure is generated in the latter in order to convey material from the supply vessel to the pressurized material vessel and the valve mentioned is opened. Another possible embodiment is where the measuring device is an ultrasonic measuring device. A preferred embodiment is where the measuring device takes the form of a vibrating fork measuring device. Such electronically controlled measuring devices provide the user with fundamental certainty for operation of his installation.

These and other features, advantages and objects of the present invention will be further understood and appreciated by those skilled in the art by reference to the following specification, claims and appended drawings.

### BRIEF DESCRIPTION OF THE DRAWINGS

FIG. 1 is a side schematic view of a system for conveying adhesives embodying the present invention.

### DETAILED DESCRIPTION OF THE PREFERRED EMBODIMENT

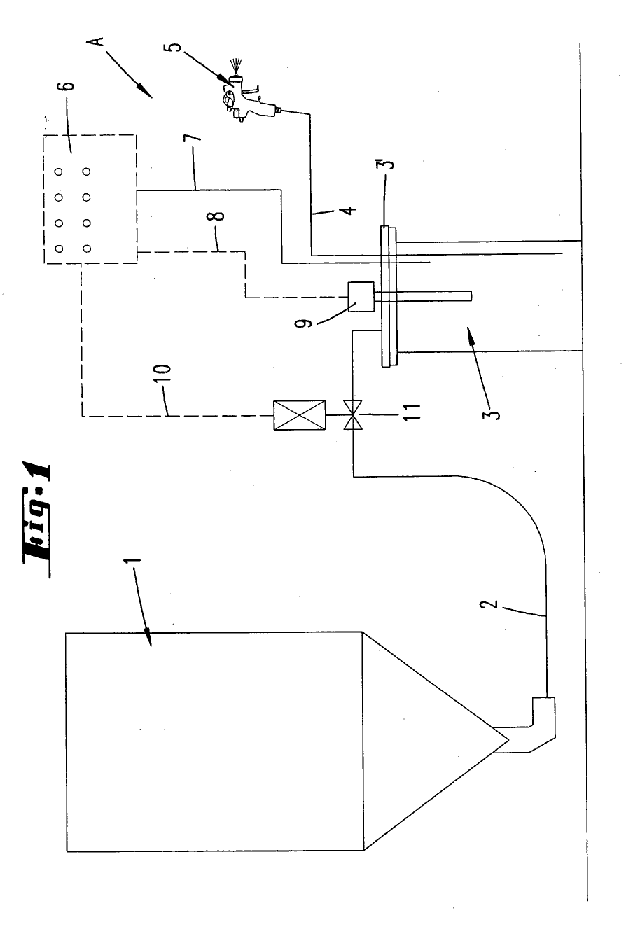

Below an embodiment is explained in greater detail referring to the diagram of an arrangement according to the invention shown in FIG. 1, which only represents an example.

The diagram in FIG. 1 shows one possible arrangement A for the gentle conveyance of sensitive adhesives, particularly dispersion adhesives and/or abrasive media, which, for the sake of simplicity, are not illustrated here.

Arrangement A consists of an approximately silo-shaped supply vessel 1, which is connected to a pressurized material vessel 3 via a connecting pipe 2. In addition, the pressurized material vessel 3 is connected to a spray gun 5, constituting an applicator, via discharge pipe 4. The spray gun 5 is known from utility model DE 297 14 302 U1 mentioned at the outset so it will not be described in any further detail here.

Furthermore, an electronically regulated controller 6 is a constituent part of arrangement A, whereby controller 6 in the illustrated example of arrangement A monitors three task methods within this arrangement A. On the one hand, controller 6 acts upon a pressure pipe 7, which is connected to the pressurized material vessel 3. On the other hand, an electronic line 8 is proposed which is connected to the level measuring device 9 positioned on pressurized material vessel 3. There is also a control line 10, by which it is possible to control a valve 11 positioned in connecting pipe 2 between supply vessel 1 and pressurized material vessel 3.

Pressure pipe 7 is also used for subjecting the pressurized material vessel to negative pressure. Alternatively, a separate negative pressure pipe, which is not shown on the diagram, can also be provided.

Discharge pipe 4, passing through cover 3′ of pressurized material vessel 3 with a seal, projects into the bottom area of pressurized material vessel 3, maintaining a distance from the bottom. Pressure pipe 7, which also passes through cover 3′ with a seal, ends at a short distance below cover 3′, whereby the latter seals off pressurized material vessel 3.

Furthermore, cover 3′ supports measuring device 9, which, penetrating cover 3′, dips like a probe into pressurized material vessel 3, which has an explosion-proof seal.

One end of the connecting pipe mentioned, 2, also penetrates cover 3′ of pressurized material vessel 3 with a seal.

Supply vessel 1, the size of which is many times larger than pressurized material vessel 3, supplies a very large quantity of application medium. Whilst material vessel 3 can be placed directly in the working area, supply vessel 1 can, for example, be positioned at a distance from pressurized material vessel 3, for example in a supply vessel building.

The volume of the application medium inside pressurized material vessel 3 is monitored by measuring device 9. The latter can take the form of an ultrasonic measuring device but also a vibrating fork measuring device. If a preset threshold level is detected on measuring device 9 because the level of the application medium has dropped, a negative pressure is generated inside the pressurized material vessel, using controller 6 and pressure pipe 7. Accordingly, using controller 6 and control pipe 10, valve 11 is opened out of the position which is closed in normal operation when applying the medium with spray gun 5, after which the supply medium, subject to negative pressure, can flow out of supply vessel 1 into material vessel 3 until measuring device 9 detects an appropriate level in material vessel 3.

The pumpless transfer of medium from supply vessel 1 into pressurized material vessel 3 is also supported by the atmospheric pressure on the application medium kept in supply vessel 1 and by its potential energy, so inside pressurized material vessel 3 a relatively low negative pressure of 0.5 bar, for example, is sufficient. Alternatively, or in addition, positive pressure can also be generated in supply vessel 1 via a facility not illustrated.

When the preset level in pressurized material vessel 3 has been reached, valve 11 is closed, after which a positive pressure of approximately 5 to 8 bar, preferably monitored by controller 6, is again generated in pressurized material vessel 3 in order to apply the medium via spray gun 5.

Valve 11, proposed in the arrangement illustrated, may take the form of a slide valve. However, there could also be a solution in which the valve is provided by a non-return valve, which is kept in the closed position by positive pressure being exerted during material application operations and is shifted to the open position only on account of the negative pressure generated for refilling in pressurized material vessel 3, and possibly on account of the potential energy of the application medium in supply vessel 1 acting on the non-return valve.

The intermittent supply of adhesive, which is sensitive in conveyance, and/or the abrasive medium, triggered by applying negative or positive pressure as described above, acts gently on the functional components.

The above description is considered that of the preferred embodiments only. Modification of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

1. A method for conveying an adhesive medium comprising:
conveying the adhesive medium from a pressurized material vessel to an applicator and intermittently refilling the pressurized material vessel from a supply vessel by exerting negative or positive pressure.

2. A method as in claim 1, wherein the refilling is accomplished by generating negative pressure in the pressurized material vessel and simultaneously forcing a valve in a connecting pipe between the pressurized material vessel and the supply vessel into an open position.

3. A method as in claim 1, wherein the supply vessel is positioned above the pressurized material vessel and refilling is performed by positive pressure acting on the supply vessel in the form of potential energy and atmospheric pressure after a valve in the connecting pipe between the pressurized material vessel and the supply vessel is forced into an open position.

4. A method as in claim 1, wherein refilling is performed by positive pressure acting on the supply from the supply vessel, after a valve in a connecting pipe between the pressurized material vessel and the supply vessel has been forced into an open position.

5. A method as in claim 1, comprising coupling a second pressurized material vessel to the pressurized material vessel, wherein one of the pressurized material vessels is refilled whilst the medium is still being conveyed from the other pressurized material vessel.

6. An arrangement for conveying adhesives to an applicator comprising a pressurized material vessel and a supply vessel, wherein the pressurized material vessel and the supply vessel are connected to one another by a pipe, which can be shut off by a valve and wherein the adhesive can be conveyed from the supply vessel into the pressurized material vessel solely by exertion of pressure.

7. An arrangement as in claim 6, wherein the pressure is negative pressure, and the negative pressure is generated in the pressurized material vessel for conveyance from the supply vessel.

8. An arrangement as in claim 6, wherein the pressure is positive pressure and the positive pressure is generated by potential energy and/or increasing the pressure.

9. An arrangement as in claim 6, wherein a level measuring device is provided and allocated to the pressurized material vessel.

10. An arrangement as in claim 9, wherein the measuring device is an ultrasonic measuring device.

11. An arrangement as in claim 9, wherein the measuring device is a vibrating fork measuring device.

12. An arrangement as in claim 6, further including a second pressurized material vessel coupled to the first-mentioned pressurized material vessel, characterized by the fact that two pressurized material vessels coupled to one another are provided.
